(19) United States
(12) Patent Application Publication
(10) Pub. No.: US 2003/0217035 A1
(43) Pub. Date: Nov. 20, 2003

(54) System and method for integrating and processing data from different data sources

(76) Inventor: Chih-Chung Lai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/273,495

(22) Filed: Oct. 18, 2002

(30) Foreign Application Priority Data
May 17, 2002 (TW) 09/1110316

(51) Int. Cl. G06F 7/00

(52) U.S. Cl. 707/1

(57) ABSTRACT

A data integrating and processing system (10) includes: a database (102) for storing data; a database server (101) connected with the database for receiving and processing data on production forecasting and ordering; and computer terminals (103) connected with the database server for searching for data stored in the database. The database server includes: a data receiving module (201) for receiving data from a customer system (12), supplier systems (13), carrier systems (14) and an ERP system (16) through respective networks (11, 15); a data sending module (202) for sending data to the customer system, the supplier systems, the carrier systems and the ERP system through the networks; a data transformation module (203) for transforming a format of received data; a data integration module (204) for integrating received data with data stored in the database; and a data saving module (205) for saving processed data in the database.

### BACKGROUND OF INVENTION

1. Field of the Invention

The present invention relates to a system and method for integrating and processing data, and particularly to a system and method which receives data from multiple data sources, changes a format of the data and automatically integrates received data with data stored in a database.

2. Description of Related Art

Within the computer, consumer electronic products and communication industry (the so-called “3C” industry), the process whereby a product progresses from production to sale can be viewed as a product supply chain. The major role players in such chain include the brand owner, component supplier, manufacturer, carrier, and retailer. These players are respectively responsible for product ordering, component supply, product manufacturing, component and product transportation, and product sales. This supply chain flows from product ordering through product sale, and the swiftness and smoothness of the flow benefits every player along the way. Product ordering by the brand owner is the driving force of the supply chain, therefore a speedy and smooth ordering procedure is vital. Direct role players at this end of the supply chain include the brand owner, component supplier, manufacturer, and carrier. How to coordinate these roles for the purpose of achieving a fast and smooth ordering procedure has always been an important concern in the 3C industry.

One problem concerned is data interchange between the above-mentioned role players. Each role player may be an enterprise having its own unique computer information system. For example, a purchase order and other related procedures can be handled by way of Electronic Data Interchange (EDI) through a network that links the brand owner's system, the component supplier's system, and the manufacturer's system. However, each of these systems may use different electronic data formats. There is no known satisfactory system or method that can speedily integrate different electronic data formats in order to increase the efficiency of ordering procedures.

Accordingly, what is needed is a system and method which can overcome the abovementioned problems.

### SUMMARY OF THE INVENTION

One objective of the present invention is to provide a system that receives data from multiple data sources, changes a format of the data, and automatically integrates received data with data stored in a database.

Another objective of the present invention is to provide a method that receives data from multiple data sources, changes a format of the data, and automatically integrates received data with data stored in a database.

To achieve the first above-mentioned object, a system of the present invention for integrating and processing data comprises a database for storing data; a database server connected with the database for receiving and processing data on production forecasting and ordering; and a plurality of computer terminals connected with the database server for searching for data stored in the database. The database server comprises: a data receiving module for receiving data from a customer system, a plurality of supplier systems, a plurality of carrier systems and an enterprise resource planning (ERP) system through respective networks; a data sending module for sending data to the customer system, the supplier systems, the carrier systems and the ERP system through the networks; a data transformation module for transforming a format of received data; a data integration module for integrating received data with data stored in the database; and a data saving module for saving processed data in the database.

To achieve the second above-mentioned object, a method of the present invention for integrating and processing data comprises the following steps: receiving data and identifying the data source; checking a format of the received data; transforming the format of the received data into a format that an internal management information system uses; integrating the received data with data stored in a database corresponding to the data source; and sending the integrated data to the internal management information system.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a view of hardware infrastructure that includes a data integrating and processing system in accordance with a preferred embodiment of the present invention, a customer system, an ERP system, a plurality of supplier systems and a plurality of carrier systems;

FIG. 2 is a detailed illustration of function modules of a database server of the data integrating and processing system of FIG. 1;

FIG. 3 is a main flowchart of operation of the data integrating and processing system of FIG. 1;

FIG. 4 is a flowchart of procedure when data are obtained from the customer system of FIG. 1;

FIG. 5 is a flowchart of procedure when data are obtained from the ERP system of FIG. 1; and

FIG. 6 is a flowchart of procedure when data are obtained from any supplier system or any carrier system of FIG. 1.

### DETAILED DESCRIPTION OF THE INVENTION

Reference will now be made to the drawing figures to describe the present invention in detail.

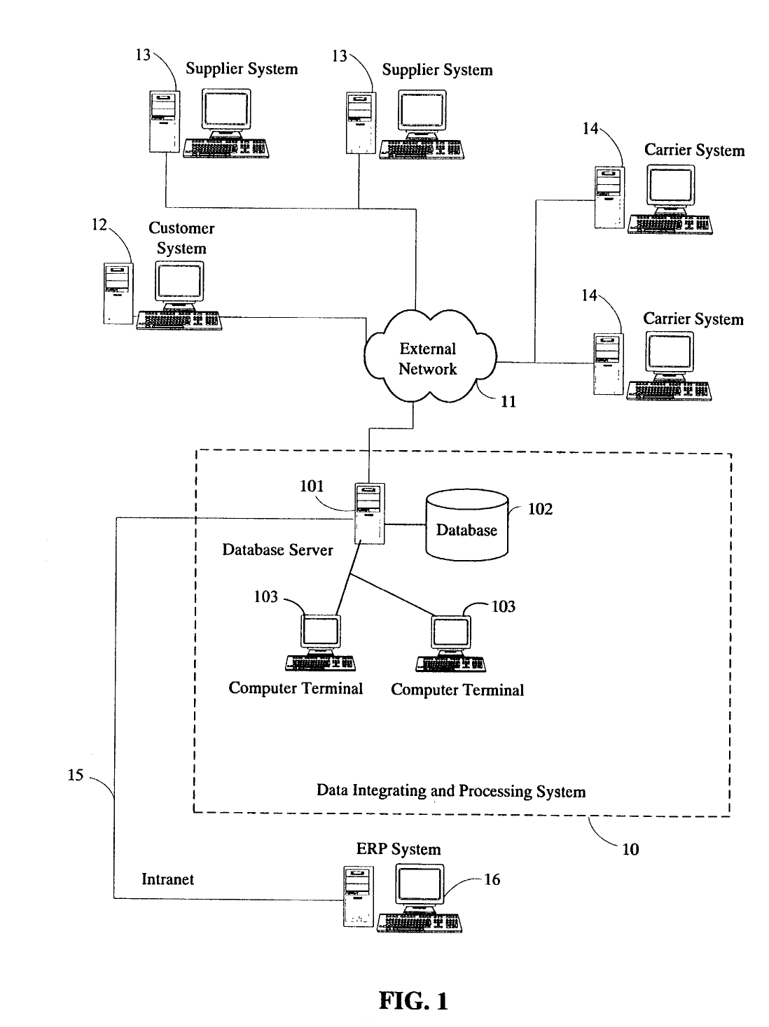

FIG. 1 is a view of hardware infrastructure including a data integrating and processing system 10 in accordance with a preferred embodiment of the present invention. The data integrating and processing system 10 comprises a database server 101 and a database 102. The data integrating and processing system 10 is connected to a customer system 12, multiple supplier systems 13 and multiple carrier systems 14 by an external network 11 that can be the Internet or an extranet. An Enterprise Resource Planning (ERP) system 16 is connected to the data integrating and processing system 10 via an intranet 15 that can be a local area network (LAN). The ERP system 16 is an internal management information system (MIS) of an enterprise that uses the data integrating and processing system 10. The database server 101 receives and processes data from the customer system 12, the supplier systems 13, the carrier systems 14 and the ERP system 16. The processed data are stored in the database 102. A user of the customer system 12 can be an employee of a customer's enterprise. A user of the supplier system 14 can be an employee of a supplier's enterprise. A user of the carrier system 13 can be an employee of a carrier's enterprise. A plurality of computer terminals 103 is connected to the database server 101, for users to search for data stored in the database 102.

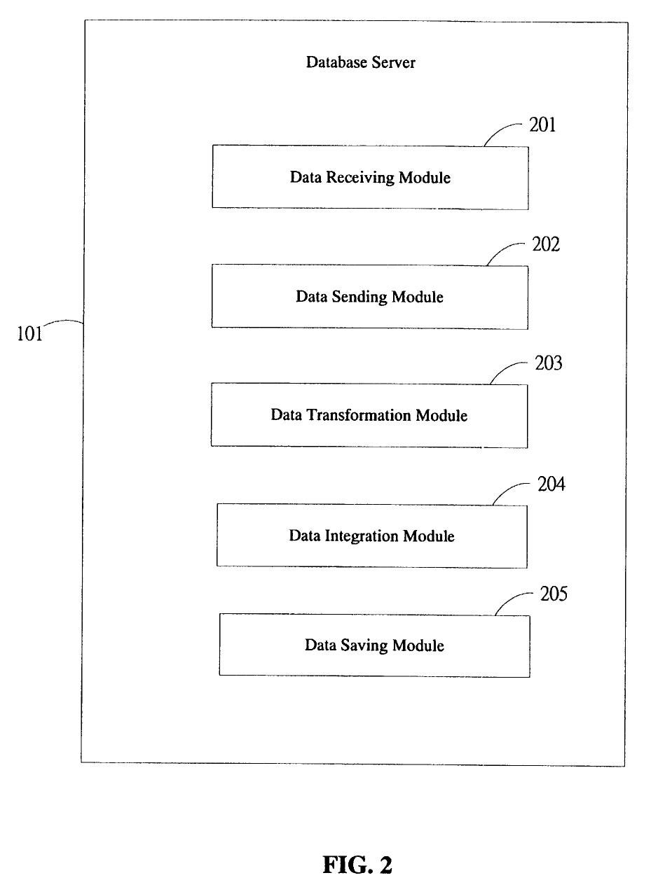

FIG. 2 is a detailed illustration of function modules of the database server 101 of the data integrating and processing system 10. The database server 101 includes: a data receiving module 201 for receiving data from the customer system 12, the supplier systems 14, the carrier systems 13 and the ERP system 16; a data sending module 202 for sending data to the customer system 12, the supplier systems 13, the carrier systems 14 and the ERP system 16; a data transformation module 203 for transforming a format of data; a data integration module 204 for integrating data from a same data source; and a data saving module 205 for saving processed data. The data formats that can be transformed include Electronic Data Interchange (EDI) format, Hypertext Markup Language (HTML) format, E-mail format, and Extensible Markup Language (XML) format. The data integrating module 204 integrates received data with data stored in the database 102. For example, when the database server 101 receives data from a supplier “X” on confirmation of shipment of 1,000 pieces of cargo “A”, the data integration module 204 automatically identifies supplier “X” data in the database 102 and integrates the received data with the supplier “X” data in the database 102. The 1,000 pieces of cargo “A” is added in the quantity of cargo “A” of the supplier “X” in the database 102.

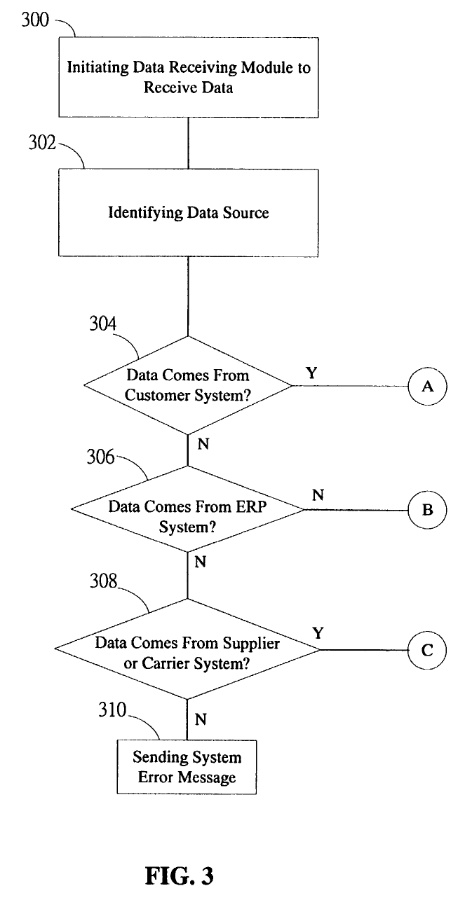

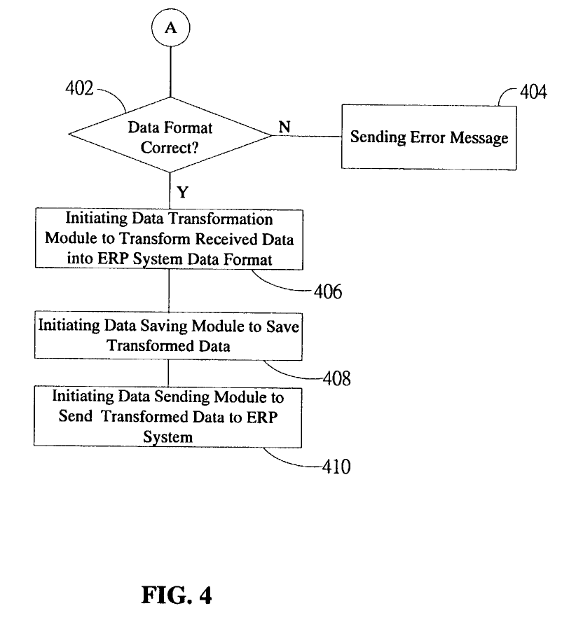

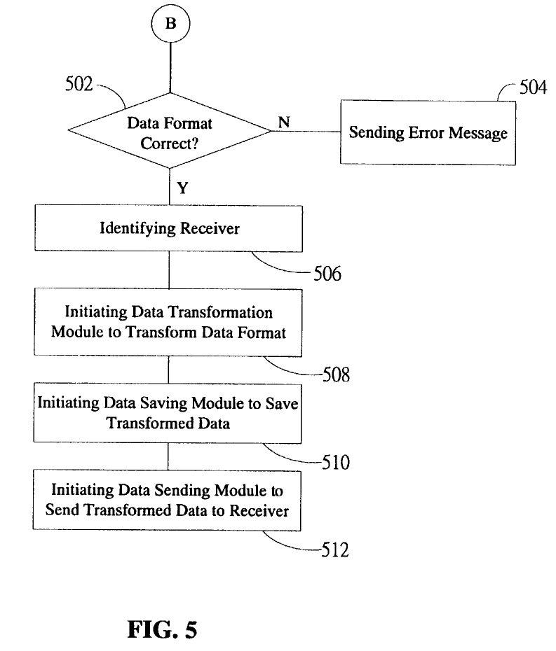

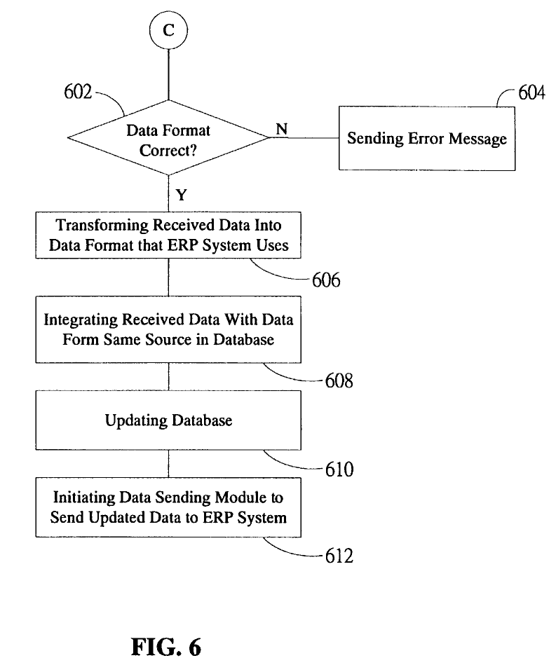

FIG. 3 is a main flowchart of operation of the data integrating and processing system 10. In step 300, the data integrating and processing system 10 initiates the data receiving module 201 to receive data. Formats of the data include EDI format, HTML format, E-mail format and XML format, all of which are used by the customer system 12, the supplier systems 13, the carrier systems 14 and the ERP system 16. In step 302, the data integrating and processing system 10 identifies a data source. In step 304, the data integrating and processing system 10 checks whether the received data are obtained from the customer system 12. If the data are obtained from the customer system 12, the procedure proceeds to step “A”, which is described in detail below with reference to FIG. 4. If the data are not obtained from the customer system 12, in step 306, the data integrating and processing system 10 checks whether the received data are obtained from the ERP system 16. If the data are obtained from the ERP system 16, the procedure proceeds to step “B”, which is described in detail below with reference to FIG. 5. If the data are not obtained from the ERP system 16, in step 308, the data integrating and processing system 10 checks whether the received data are obtained from any supplier system 13 or any carrier system 14. If the data are obtained from any supplier system 13 or any carrier system 14, the procedure proceeds to step “C”, which is described in detail below with reference to FIG. 6. If the data are not obtained from any supplier system 13 or any carrier system 14, a system error message is sent to the ERP system 16 and the procedure is ended.

FIG. 4 is a flowchart of procedure when the data are obtained from the customer system 12. In step 402, the data integrating and processing system 10 checks whether the data format is correct. If the data format is not correct, in step 404, an error message is sent to the ERP system 16 and the procedure is ended. If the data format is correct, in step 406, the data transformation module 203 is initiated to transform the received data into the ERP system 16 data format. In step 408, the data saving module 205 is initiated to save the transformed data. In step 410, the data sending module 202 is initiated to send the transformed data to the ERP system 16 for processing therein.

FIG. 5 is a flowchart of procedure when the data are obtained from the ERP system 16. In step 502, the data integrating and processing system 10 checks whether the data format is correct. If the data format is not correct, in step 504, an error message is sent to the ERP system 16 and the procedure is ended. If the data format is correct, in step 506, the data integrating and processing system 10 identifies the receiver of the data. The receiver may be the customer system 12, any supplier system 13 or any carrier system 14. In step 508, the data transformation module 203 is initiated to transform the data into a format that the receiver can read. Such format may be EDI format, HTML format or E-mail format. In step 510, the data saving module 205 is initiated to save the transformed data in the database 102. In step 512, the data sending module 202 is initiated to send the transformed data to the identified receiver.

FIG. 6 is a flowchart of procedure when the data are obtained from any supplier system 13 or any carrier system 14. In step 602, the data integrating and processing system 10 checks whether the data format is correct. If the data format is not correct, in step 604, an error message is sent to the ERP system 16 and the procedure is ended. If the data format is correct, in step 606, the data transformation module 203 is initiated to transform the received data into the ERP system 16 data format. In step 608, the data integration module 204 is initiated to integrate the received data with data from the same source in the database 102. For example, if the received data is obtained from supplier “X,” then the data is integrated with data on supplier “X” in the database 102. In step 610, the database 102 is updated. In step 612, the data sending module 202 is initiated to send the updated data in the database 102 to the ERP system 16.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for integrating and processing data received from different data sources, the system comprising:
a database for storing received data;
a database server connected with the database for processing received data, the database server comprising
a data receiving module for receiving data from a customer system, a supplier system, a carrier system and an enterprise resource planning system through at least one network,
a data sending module for sending data to the customer system, the supplier system, the carrier system and the enterprise resource planning system through the at least one network,
a data integration module for integrating received data with data stored in the database, and
a data transformation module for transforming a format of received data; and
a plurality of computer terminals connected with the database server for searching for data stored in the database.

2. The system described in claim 1, wherein the database server further comprises a data saving module for saving processed data in the database.

3. The system described in claim 1, wherein the format of received data comprises any one or more of Electronic Data Interchange format, Hypertext Markup Language format, E-mail format, and Extensible Markup Language format.

4. A method for integrating and processing data received from different data sources, the method comprising the following steps:
receiving data and identifying a data source;
checking a format of the received data;
transforming the format of the received data into a format that an internal management information system uses;
integrating the received data with data stored in a database corresponding to the data source; and
sending the integrated data to the internal management information system.

5. The method as described in claim 4, further comprising the step of:
updating data in the database after the received data is integrated with data stored in the database.

6. The method as described in claim 4, further comprising the step of:
sending an error message to the internal management information system when the format of the received data is not correct.

7. The method as described in claim 4, wherein the format of the received data comprises any one or more of Electronic Data Interchange format, Hypertext Markup Language format, E-mail format, and Extensible Markup Language format.

8. A method for integrating and processing data received from different data sources, the method comprising the following steps:
receiving data from an internal management information system;
checking a format of the received data;
identifying a receiver of the received data;
transforming the format of the received data into a format that the receiver uses; and
sending the transformed data to the receiver.

9. The method as described in claim 8, further comprising the step of:
saving the transformed data in a database.

10. The method as described in claim 8, further comprising the step of:
sending an error message to the internal management information system when the format of the received data is not correct.

11. The method described in claim 8, wherein the format of the received data comprises any one or more of Electronic Data Interchange format, Hypertext Markup Language format, E-mail format, and Extensible Markup Language format.

12. A method of handling a purchase order for a manufacturer, comprising:
providing a central computer connected to a customer system, a supplier system and a carrier system via an external network;
receiving a purchase order from the customer system;
transforming a format of said purchase order if formats used in said customer system the supplier system, the carrier system and the central computer are not all identical;
sending the transformed, if necessary, purchase order to the supplier system and said carrier system;
receiving feedbacks from the supplier system and said carrier system;
integrating said received feedbacks and other internal information of the manufacture; and
sending the integrated feedbacks and other internal information to the customer system so that it is easy for a corresponding customer to amend the purchase order according to the feedbacks and his own need.

13. The method described in claim 12, wherein said purchase order is either an estimate one or a real one.
